(19) United States
(12) Patent Application Publication
(10) Pub. No.: US 2026/0328273 A1
(43) Pub. Date: Oct. 22, 2026

(54) TENSIONING DEVICE, DRIVE SYSTEM, VEHICLE AND TENSIONING METHOD

(71) Applicant: E2 DRIVES, Wavre (BE)

(72) Inventors: Arthur Deleval, Wavre (BE); Christophe Deleval, Wavre (BE)

(73) Assignee: E2 DRIVES, Wavre (BE)

(21) Appl. No.: 19/491,068

(22) PCT Filed: Jul. 25, 2024
(86) PCT No.: PCT/EP2024/071124

§ 371 Date: Dec. 8, 2025

(30) Foreign Application Priority Data
Jul. 27, 2023 (BE) BE2023/5618

(51) Int. Cl. F16H 7/12; F16H 7/08; F16H 57/035

(52) U.S. Cl. CPC F16H 7/1263; F16H 7/1281; F16H 57/035; F16H 2007/0865; F16H 2007/088; F16H 2007/0891; F16H 2007/0893; F16H 2007/0897

(57) ABSTRACT

A device for tensioning a deformable transmission element is provided. The device includes a tension adjuster for the transmission element, and a resilient member, the tension adjuster being movable through a first stroke in which the device is configured to tension the transmission element with a first tension by way of the resilient member, the deformation of which being limited, and beyond the first stroke, through a second stroke, the device being able to tension the transmission element with a second additional tension by way of the tension adjuster, the second stroke depending on the second tension to be applied in the transmission element. A transmission system, a vehicle, and a tensioning method are further disclosed.

### TECHNICAL FIELD

The present invention relates to a device for tensioning a transmission element, a drive system with the device, a vehicle with the system and a tensioning method.

### PRIOR ART

There are devices enabling a transmission belt to be tensioned. These devices may be spring-loaded tensioners. The disadvantage of these devices is that they vibrate during operation. One solution to the vibrations is to add damping elements, but this has the disadvantages of being costly and complex. These devices may also be fixed tensioners during use. The disadvantage of these devices is that they do not allow sufficient tension to be applied to the belt in operating modes where the load is potentially high. Alternatively, if a very high tension is applied to the belt to cope with these high load operating modes, this causes too much friction and high stresses on all the elements of the transmission.

The document U.S. Pat. No. 3,785,220 describes a belt clutch device comprising a drive pulley and a pulley driven by the drive pulley by means of an endless belt initially loosely fitted around the drive and driven pulleys. An arm is mounted so that it can pivot at one end within the perimeter of the belt. A belt tension pulley is mounted in rotation at the other end of the arm and in contact with the inner surface of the belt. A return spring connected to the arm moves the tension pulley away from the inner surface of the belt. An actuating device, and a connecting element connected between the actuating device and the arm, is adapted to pivot the arm against the force of the return spring and into a predetermined angular relationship with the belt, so that the tensioning pulley fully tensions the belt. This document does not provide for tensioning of the belt by the spring. The spring, on the other hand, acts as a return spring to return the arm to a disengaged position. The document U.S. Pat. No. 6,030,305 describes a belt tensioning device. The device allows a belt to be tensioned between two pulleys—without acting on the belt itself, but by increasing the distance between the pulleys. The device described in this document provides a tension reference point in order to obtain the correct setting with tension springs whose length changes over time, possibly because they have undergone plastic deformation under constant load.

Generally speaking, the current devices do not allow for adaptation to a wide range of transmitted torque.

There is a need for a tensioning device that can accommodate a wide range of transmitted torque.

### SUMMARY OF THE INVENTION

To this end, the invention proposes a device for tensioning a deformable transmission element comprising means for adjusting the tension in the transmission element, and a resilient member, the adjustment means being movable: Through a first stroke, the device being able to tension the transmission element with a first tension by the resilient member, the deformation of which being limited, and, beyond the first stroke, Through a second stroke, the device being able to tension the transmission element with a second additional tension by the adjustment means, the second stroke depending on the second tension to be applied in the transmission element.

According to an embodiment, the device further comprises a carrier, the device being able to tension the transmission element via the carrier.

According to an embodiment, the device comprises a roller mobile in rotation with respect to the carrier, the carrier being able to tension the transmission element by means of the roller.

According to an embodiment, the resilient member is on the carrier.

According to an embodiment, the deformation of the resilient member is limited by abutment.

According to an embodiment, the deformation of the resilient member is limited by abutment by the carrier.

According to an embodiment, the deformation of the resilient member is limited by abutment by the adjustment means abutting against the carrier at the end of the first stroke or by the resilient member abutting against the carrier.

According to an embodiment, Through the first stroke of the adjustment means, the carrier of the device is able to tension the transmission element with the first tension by the resilient member, the deformation of which being limited, the adjustment means acting on the resilient member into limited deformation by an abutment against the carrier, and, beyond the first stroke, Through the second stroke of the adjustment means, the carrier of the device is able to tension the transmission element with the second additional tension by the adjustment means acting on the carrier, the second stroke depending on the second tension to be applied in the transmission element.

According to an embodiment, the resilient member is chosen from the group comprising a leaf spring, a helical spring, a spiral torsion spring, a stud made of resilient material, a structural piece designed to provide the appropriate stiffness for the tension to be applied in the transmission element.

According to an embodiment, the adjustment means are a screw or an eccentric.

The invention also relates to a drive system, comprising a deformable transmission element, the device as previously described, the device being able to tension the transmission element.

According to an embodiment, the system further comprises a casing, the transmission element and the device being at least partly within the casing, the adjustment means being accessible from outside the casing, the casing comprising a sight glass for checking the first stroke and/or the second stroke of the adjustment means.

According to an embodiment, the device is also able to tension the transmission element when the transmission element elongates during operation, the resilient member compensating for the elongation of the transmission element.

The invention also relates to a vehicle with the drive system as described above.

According to an embodiment, the vehicle is a bicycle or motorbike.

The invention also relates to a method of tensioning a transmission element in a drive system, the method comprising
The supply of a system as described above,
The tensioning of the transmission element by the device, comprising
Through the first stroke of the adjustment means, the transmission element is tensioned with a first tension by the resilient member, the deformation of which being limited, then, beyond the first stroke,
Through the second stroke of the adjustment means, the transmission element is tensioned with a second additional tension by the adjustment means, the second stroke depending on the second tension to be applied in the transmission element.

According to one embodiment, the device also comprises a carrier, the device being able to tension the transmission element via the carrier, the deformation of the resilient member is limited by abutment by the adjustment means abutting against the carrier at the end of the first stroke or by the resilient member abutting against the carrier.

According to one embodiment, the system further comprises a casing, the transmission element and the device being at least partly within the casing, the adjustment means being accessible from outside the casing, the casing comprising a sight glass, the method comprising checking the first stroke and/or the second stroke of the adjustment means through the sight glass.

According to one embodiment, the method further comprises tensioning the transmission element by the resilient member of the device upon elongation of the transmission element during operation, the resilient member compensating for the elongation of the transmission element.

The use of the verb “comprise” and its variants, as well as its conjugations in this document, may not in any way exclude the presence of elements other than those mentioned. The use in this document of the indefinite article “a”, “an”, or the definite article “the” to introduce an element does not exclude the presence of a plurality of these elements.

The terms “first”, “second”, “third”, etc. are used in this scope of this document exclusively to differentiate between different elements, without implying any order between these elements.

All of the preferred embodiments and all of the advantages of the tensioning device according to the invention are transposed mutatis mutandis to the present drive system, vehicle, and tensioning method, and vice versa. The various embodiments may be considered individually or in combination.

### BRIEF DESCRIPTION OF THE FIGURES

Further characteristics and advantages of the present invention will become apparent from the following detailed description, for the understanding of which reference is made to the attached figures which show:

FIG. 1, a schematic view according to an example of the invention;

FIG. 2, a schematic view of the operation of FIG. 1;

FIG. 3, a schematic view of the operation of FIG. 1;

FIG. 4, a view of another example of the invention;

FIG. 5, a view of the operation of FIG. 4;

FIG. 6, a view of the operation of FIG. 4;

FIG. 7, a graph showing the elongation as a function of the tension;

FIG. 8, a graph showing the tensioning process.

The drawings in the figures are not to scale. Similar elements are generally denoted by similar references in the figures. In the scope of this document, the same or similar elements may have the same references. Furthermore, the presence of reference numbers or letters in the drawings may not be considered as limiting, even when these numbers or letters are indicated in the claims.

### DETAILED DESCRIPTION OF EMBODIMENTS OF THE INVENTION

The invention relates to a device for tensioning a deformable transmission element. The device comprises means for adjusting the tension in the transmission element and a resilient member. The adjustment means are movable along a first stroke, the device being able to tension the transmission element with a first tension by the resilient member, the deformation of which being limited. Beyond the first stroke, the adjustment means are movable along a second stroke, the device being able to tension the transmission element with a second additional tension by the adjustment means, the second stroke depending on the second tension to be applied in the transmission element. The device allows to tension the transmission element for a normal load operation mode and to tension the transmission element for a high load operation mode. The device therefore allows adaptation to different operating modes.

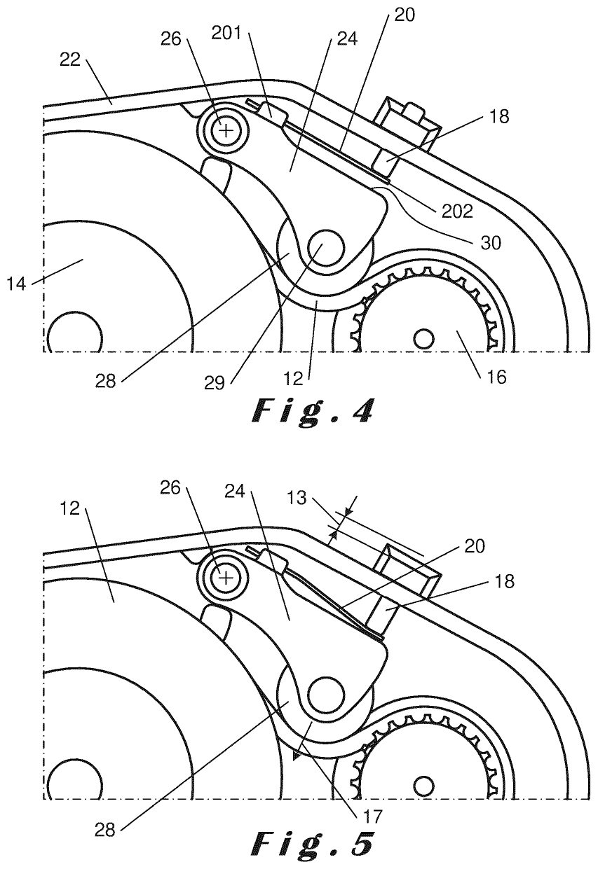

The figures show a tensioning device 10 in a drive system 11 as well as the operation. The device 10 allows tensioning a transmission element 12 in the drive system 11. The transmission element 12 may be deformable. The transmission element 12 may be deformable in the sense that its shape can be altered. The transmission element 12 may be deformable in the sense that elongation may occur in the transmission element 12. The transmission element 12 can be a chain, a belt or a flexible band. If the transmission element 12 is a belt, the belt is preferably made of a flexible material and is preferably toothed or notched on its inner surface (see FIG. 4). The transmission element 12 may transmit power between two or more wheels or pulleys 14, 16. The transmission element 12 enables power to be transmitted between parallel axes set in rotation, The transmission element 12 enables power to be transferred between the pulley 14 and the pulley 16—possibly in both directions, depending on the direction of rotation of the pulleys. One of the pulleys, for example pulley 14, may be driven by a motor not shown in the figures. The power from the pulley 14 may be transferred by the transmission element 12 to the pulley 16. In particular, during tensioning of the transmission element 12, the centre distance between the pulleys 14, 16 (or more) remains unchanged.

The device 10 may also include means 18 for adjusting the tension in the transmission element 12. The device 10 acts (directly) on transmission element 12 to tension it (while maintaining the center distance between the pulleys and not by spacing the pulleys apart). The device 10 acts (directly) on the transmission element 12. The device 10 is in contact with the transmission element to tension it. By adjusting the adjustment means 18, the tension in the transmission element 12 can be adjusted, determined. The adjustment means 18 are movable, which allows the tension in the transmission element 12 to be adjusted. The adjustment means 18 can be translationally and/or rotationally movable. The adjustment means 18 can be moved along a stroke, allowing the tension in the transmission element to be adjusted. The nature of the stroke depends on the type of mobility of the adjustment means 18. The adjustment means 18 can be moved along a first stroke 13 and a second stroke 15, depending on the desired tension to be applied to the transmission element 12. According to each of the two strokes, the adjustment means 18 are continuously movable (adjustable) (i.e. according to a non-discrete number of positions of the adjustment means) to ensure precise adjustment of the tension. The tensioning of transmission element 12 is achieved at the end of the first and second strokes. The adjustment means 18 may be a screw. The screw is mobile in rotation and translation, with the rotation of the screw enabling the translation of the screw. The screw has a linear translational stroke (which depends on the rotation given to the screw). The adjustment means 18 may be an eccentric. The eccentric is mobile in rotation. The eccentric has an angular rotation stroke. The adjustment means 18 may also be thickness shims, a slide whose degree of freedom can be locked, an adjustment lever that can be locked, a cam and its locking mechanism, a hydraulic piston, a pneumatic, hydraulic, piezoelectric, or electromagnetic actuator, as well as the associated transmission and locking mechanism. The adjustment means are any means allowing the force to be adjusted and the associated locking mechanism, either by an external member (such as a ratchet or pawl) or by irreversibility.

The device 10 may also include a resilient member 20. The resilient member 20 allows a force to be exerted to tension the transmission element 12. The deformation of the resilient member 20 allows the transmission element 12 to be tensioned. The adjustment means 18 are able to deform the resilient member 20. By moving along its stroke, the adjustment means 18 are able to deform the resilient member 20. The resilient member 20 is deformed during the stroke of the adjustment means 18. Preferably, the deformation of the resilient member 20 is limited. The resilient member 20 is able to deform up to a limit. The deformation of the resilient member 20 is possible to a certain extent. The resilient member 20 can be deformed until it comes to an abutment (mechanical abutment). The resilient member 20 may be selected from the group comprising a leaf spring, a helical spring, a spiral torsion spring, a stud made of resilient material, or a structural part designed to provide the appropriate stiffness for the tension to be applied to the transmission element 12. Other examples of resilient member can be given.

The adjustment means 18 are movable along the first stroke 13. The device 10 is then able to tension the transmission element 12 with a first tension by the resilient member. The stiffness of the resilient member 20 transmits a force 17 to the transmission element 12, which is tensioned. In a state of stress of the resilient member 20 imposed by the adjustment means 18, the resilient member 20 undergoes a given deformation. The deformation of the resilient member 10 puts tension on the transmission element 12.

Beyond the first stroke 13, the adjustment means 18 are mobile along the second stroke 15. In other words, the movement (displacement) of the adjustment means 18 to the end of the first stroke 13 then drives the adjustment means 18 into the second stroke 15. As can be seen from the figures, the second stroke beyond the first stroke means that the second stroke is a continuation of the first stroke. In the second stroke, the adjustment means 18 extends its movement further than in the first stroke. The device 10 is then able to tension the transmission element 12 with a second additional tension by the adjustment means. The second imparted tension, transmitted by the adjustment means 18 in the transmission element 12, is added to the first imparted tension, transmitted by the resilient member 20 in the transmission element 12. The second stroke 15 is a function of the second tension to be applied in the transmission element. Depending on the second tension to be applied, the adjustment means 18 are moved through the second stroke. During the movement of the adjustment means 18 over the second stroke, the resilient member 20 is held at its limited deformation, possibly by abutting. This enables the first tension to be maintained and controlled by the resilient member 20 when the second tension is applied, during the second stroke of the adjustment means 18. The sum of the two tensions (total tension) gives the desired tension, i.e. the tension that allows optimum operation for nominal use of the transmission element 12, as determined when the drive system 11 was designed. The first tension and the second tension (and therefore the total pressure) are applied precisely, over the whole of the two strokes of the adjustment means 18. The adjustment means 18 transmit a force 19 into the transmission element 12, which is set to the desired tension.

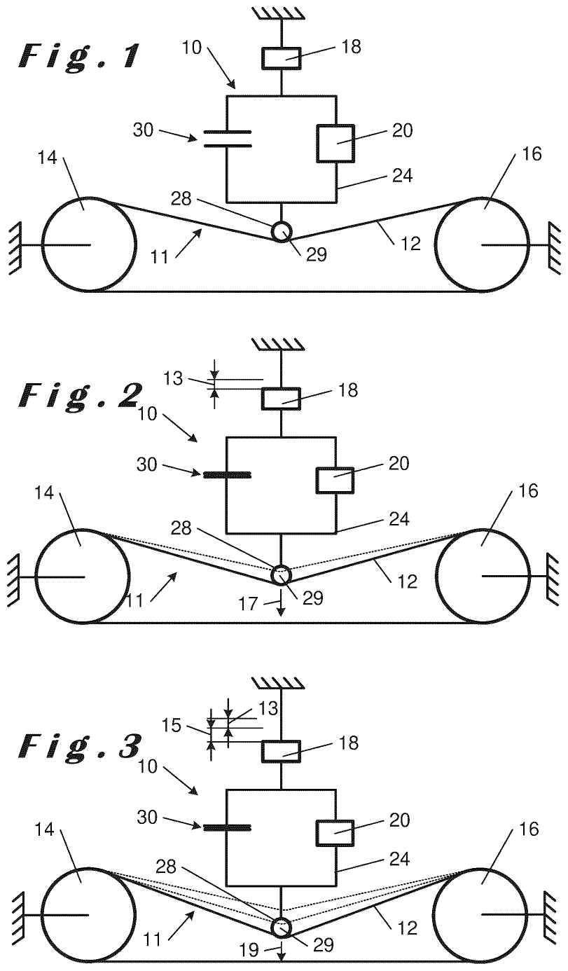

In the example shown in FIGS. 1-3, the device 10 tensions the transmission element 12 by a movement which may be translational. In the example shown in FIGS. 4-6, the device 10 tensions the transmission element 12 by a movement which may be rotational.

The device 10 may also include a carrier 24. The device 10 is able to tension the transmission element 12 via the carrier 24. The carrier is mobile. The carrier 24 may be moved in translation as shown in FIGS. 1-3, or in other words in a linear guide. The device 10 then tensions the transmission element 12 by the translational movement of the carrier. The carrier 24 shown in FIGS. 1-3 is therefore a slider 24 which is mobile in translation. The carrier 24 in the form of a slider can push or pull the transmission element 12 to tension it. In FIGS. 4-6, the carrier 24 can be rotated, or in other words guided in rotation. The device 10 then tensions the transmission element 12 by the rotational movement of the carrier. The carrier 24 shown in FIGS. 4-6 is therefore a lever 24 mobile in rotation.

It is also conceivable that the carrier 24 and the resilient member 20 could be combined.

The carrier 24 can bias the transmission element 12 by being in direct contact with the transmission element 12. Preferably, the device 10 can comprise a roller 28 which is mobile in rotation relative to the carrier 24. The roller 28 may be positioned at one end of the carrier 24. The carrier 24 is able to tension the transmission element 12 by means of the roller. In other words, the roller 28 is mounted so that it can rotate (freely) on the carrier 24 and may be pressed against the transmission element 12. The connection between the carrier 24 and the roller 28 can be represented by a bearing centered on an axis of rotation 29. The pulley forming the roller 28 may be smooth or notched.

The movement of the carrier 24 presses the roller 28 against the transmission element 12, thereby tensioning the transmission element 12. The roller 28, which is mobile in rotation on the carrier 24, allows the transmission element 12 to be acted upon while limiting friction against the transmission element 12. The carrier 24 and the roller 28 enable the transmission element 12 to be tensioned, without braking the transmission of the movement from one pulley 14, 16 to the other.

Applying tension against the transmission element 12 through the roller 28 (i.e. a third pulley) keeps the axes of rotation of the driving and driven pulleys fixed. The device can therefore be used when the pulley transmission interfaces with other elements in the environment that cannot be moved (such as a transmission downstream of the driven pulley). In addition, the invention allows an action to be taken on the slack strand of the transmission element 12 (unlike the device in U.S. Pat. No. 6,030,305, where action is taken on both strands by moving the pulleys apart). For example, in the case of a transmission element 12 in the form of a notched belt or chain, the device does not interfere with the strand that transmits the load and therefore the dynamics are better. The ratio of pre-tension to maximum torque transmitted is also better.

The resilient member 20 may be on the carrier 24. The resilient member 20 can be worn by the carrier 24. In other words, the resilient member 20 can be assembled and fixed to the carrier 24. The resilient member 20 is then driven in motion with the carrier 24. The entire resilient member 20 is driven in motion with the carrier 24. The resilient member 20 changes position during operation of the device upon movement of the carrier 24. The entire resilient member 20 changes position during operation of the device upon movement of the carrier 24. The translational movement of the carrier 24 as shown in FIGS. 1-3 causes the resilient member 20 to move in translation. In the example shown in FIGS. 1-3, the resilient member 20 may be a helical spring embedded at one end in the carrier 24. At its other end, the resilient member 20 can be loaded by the adjustment means 18. The rotational movement of the carrier 24 about its axis of rotation 26 as shown in FIGS. 4-6 causes the resilient member 20 to rotate about the axis of rotation 26. In the example shown in FIGS. 4-6, the resilient member 20 is a blade embedded at its end 201 in the carrier 24. The resilient member 20 is cantilevered over the carrier 24. At its other end 202, the resilient member 20 is acted upon by the adjustment means 18. Thus, the embedding point, the fixing point of the resilient member 20, changes position during operation of the device upon movement of the carrier 24.

Through the first stroke of the adjustment means 18, the carrier 24 (in its movement) is able to tension the transmission element 12 with the first tension by the resilient member 20. The resilient member 20 acts on the carrier 24 to tension the transmission element 12. The adjustment means 18 do not act directly on the carrier 24, but acts on the resilient member 20, which in turn acts on the carrier 24. Then, through the second stroke of the adjustment means 18, the carrier 24 (in its movement) is able to tension the transmission element 12 with a second additional tension by the adjustment means 18. The adjustment means 18 act on the carrier to tension the transmission element 12.

According to the figures, the deformation of the resilient member 20 is limited by abutment. The deformation of the resilient member may be less than its maximum deformation. The deformation of the resilient member 20 can be limited by abutment in several ways. The first stroke of the adjustment means 18 acting on the adjustment member can be limited by abutment. The adjustment means 18 are movable over a certain stroke before abutting. During this initial stroke, the adjustment means 18 deform the resilient member 20 and, at the end of this first stroke, the adjustment means 18 come to rest against an abutment. At the end of the first stroke, the resilient member 20 is deformed to a limited extent. In addition, the resilient member 20 can itself abut, which limits its deformation. The deformation of the resilient member 20 ends when the adjustment means 18 and/or the resilient member 20 are abutting.

Preferably, the deformation of the resilient member 20 can be limited by abutment by the carrier. The deformation of the resilient member 20 can be limited by abutment by the adjustment means 18 coming into abutment 30 against the carrier 24 at the end of the first stroke or by the resilient member 20 coming into abutment 30 against the carrier. The deformation of the resilient member 20 can be limited by the limitation of the first stroke of the adjustment means 18 at the a abutment 30 by the carrier 24. The first stroke of the adjustment means 18 can be limited by abutment by the adjustment means 18 abutting against the carrier 24. The first stroke of the adjustment means 18 can be limited by abutment by the resilient member 20 abutting against the carrier 24. At the end of the first stroke of the adjustment means 18, the adjustment member 18 and/or the resilient member 20 are abutting, in contact with the carrier 24.

The operation of the device 10—and more generally of the drive system 11—and a tensioning method according to the invention may occur as follows. Any description of the device and its operation can be applied to the tensioning method, and vice versa.

Through to the first stroke 13 of the adjustment means 18, the carrier 24 of the device is able to tension the transmission element 12 with the first tension by the resilient member 20, the deformation—of which being limited. The adjustment means 18 force the resilient member 20 into limited deformation by the abutment 30 against the carrier 24. During the first stroke of the adjustment means 18, the tension in the transmission element is adjusted by the deformation of the resilient member 20. The deformation of the resilient member 20, which is carried by the carrier 24, causes the carrier 24 to move, the carrier 24 acting on the transmission element 12 in tension—via the roller 28 if applicable. The adjustment of the adjustment means 18 (such as a screw) allows the resilient member 20 (such as a spring) to be deformed, which will transmit this force to the carrier 24 (for example via the connection 201), thereby increasing the tension in the transmission element 12. According to FIGS. 1-3, the carrier 24 has a translational movement. According to FIGS. 4-6, the carrier 24 has a rotating movement around the axis of rotation 26. The action of the carrier 24 on the transmission element 12 causes the transmission element 12 to be tensioned with a first tension. FIG. 2 (applicable to FIG. 5) shows the position of the transmission element in dotted lines corresponding to the position in FIG. 1.

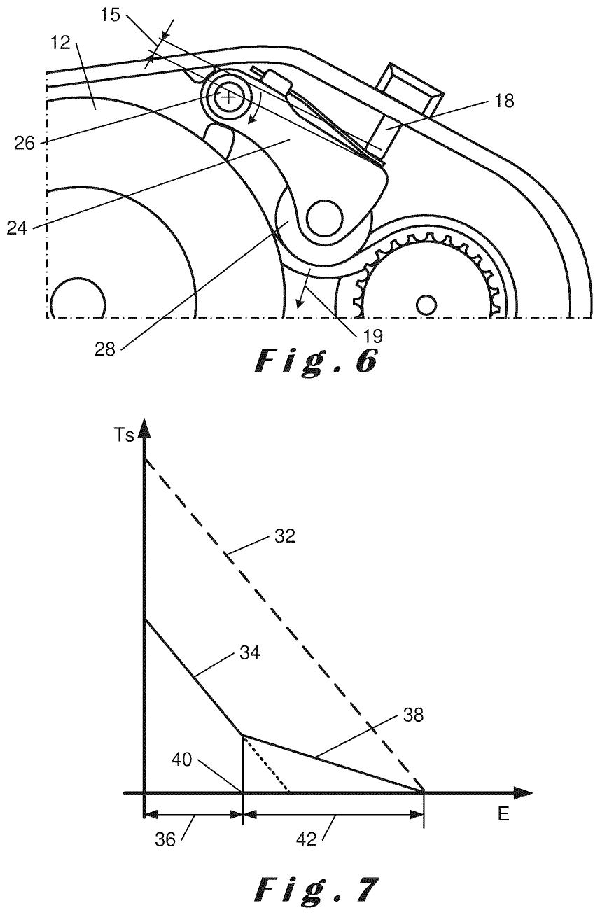

Beyond the first stroke, and through the second stroke 15 of the adjustment means 18, the carrier 24 of the device is able to tension the transmission element 12 with the second additional tension by the adjustment means 18 acting on the carrier 24. The adjustment means 18 are abutting and the resilient member 20 is limited in deformation by the abutment 30. The adjustment means 18 and the resilient member are abutting, in contact with the carrier 24. Through the second stroke 15, the adjustment means 18 act on the carrier 24 against the transmission element 12. In particular, the carrier 24 is acted upon by the adjustment means 18 and no longer solely by the resilient member 20, which is limited in its deformation. According to FIGS. 1-3, carrier 24 has a translational movement. According to FIGS. 4-6, carrier 24 has a rotating movement around the axis of rotation 26. The adjustment means 18 are in contact with the carrier 24 at the level of the abutment 30—directly or indirectly with the resilient member 20 between the adjustment means 18 and the abutment 30. The adjustment means 18 move over the second stroke depending on the second tension to be applied in the transmission element 12. During the second stroke, the resilient member 20 is locked in deformation and is driven in movement with the carrier 24. FIG. 3 (applicable to FIG. 6) shows the positions of the dotted transmission element corresponding to the positions in FIGS. 1 and 2.

The transmission element 12 is therefore tensioned in a two-phase or two-mode sequence. This two-phase tensioning sequence may correspond to a tensioning adjustment (or obtaining a pre-tension). This adjustment can be made before using the drive system 11 or during a maintenance operation. In the first phase, the first tension is imparted to the transmission element 12 by deformation of the resilient member 20. At the end of the first phase, the deformation of the resilient member 20 is limited, by abutment. In this first phase, the tension of the transmission element is controlled by the deformation of the resilient member. The resilient member is dimensioned so as to apply a (relatively) stable (and known) force (and therefore a tension) to the transmission element 12 when it is deformed to its limit. Then, in the second phase, the second tension—additional to the first tension—is imparted to the transmission element 12 by the adjustment means 18, which continues its stroke while the resilient member is inhibited. During the second phase, the device is able to tension the transmission element 12 directly. The stroke of the adjustment element 18 is continued depending on the second tension to be applied additionally in the transmission element 12. In this second phase, the tension of the transmission element 12 is controlled in motion by modifying a passage point of the transmission element. The tension can be controlled by displacement (or movement) of the device 10 (if necessary, by movement of the carrier 24 acted upon by the adjustment means 18). This displacement communicated by the adjustment means are calculated as a function of the relationship between the tension in the transmission element 12 and the resulting tension. The movement of the device 10 allows in particular to move the resilient member 20, without modifying its deformation.

In other words, by adjusting the adjustment means 18 (such as a screw), the resilient member is stressed, which will generate the first stroke 13 of the transmission element 24, until abutment of the resilient member. At this precise moment, the tension of the transmission element is known from the characteristics of the resilient member (such as the force constant of a spring kx). Then, it is possible to increase the tension of the transmission element up to the desired tension by operating the second stroke 15 of a fixed displacement (for example by screwing the screw according to a fixed displacement). The second stroke 15 is, for example, a possibly non-integer number of screw turns, giving the desired displacement, linked by the characteristics of the screw, such as the screw pitch.

The device 10 enables the tensioning sequence to be adapted to the properties of the transmission element 12. The first phase tensions the transmission element 12 to a known value, independently of deviations due to production tolerances of the transmission element 12 or other surrounding mechanical components. The second phase completes the tensioning of the transmission element 12 by adding a known displacement to the initial position obtained during the first phase.

The drive system 11 may comprise a casing 22 (visible in FIGS. 4-6 but also applicable to FIGS. 1-3). The transmission element 12 and the device 10 may be at least partly housed in the casing 22. This allows them to be protected (for example against dust, impact, etc.). The transmission element 12 may be at least partially located within the casing 22. It is possible for the transmission element 12 to be completely in the casing 22 or partially in the casing 22 on the device 10. The device 10 may also be at least partially located within the casing 22. For example, the adjustment means 18 may extend between the outside and inside of the casing 22. The adjustment means 18 can also be located in the casing 22, being accessible from outside the casing 22. The casing 22 also enables the elements constituting the invention to be supported.

The casing 22 may include a sight glass (not visible in the figures) for checking the first stroke and/or second stroke of the adjustment means 18. This ensures reliable tensioning by means of a visual check, without the need for special tools to measure force, torque or tension. The sight glass may allow the adjustment means 18 to be followed through its first stroke. The sight glass allows the adjustment means 18 to be identified when it is at the abutment 30—possibly against the carrier 24, if applicable. The sight glass allows the adjustment means 18—and potentially the resilient member—to be identified when it is in contact with the carrier 24. This allows detection that the tensioning is at the end of the first phase. The sight glass also allows the adjustment means 18 to be followed over its second stroke. The second stroke may also be determined by controlling the actuation of the adjustment means 18. The second stroke may be determined by further movement of the adjustment means 18. For example, in the form of a screw, an additional rotation of the adjustment member 18 by a certain angle determines the second stroke and thus the second additional tension. The sight glass may be covered with a part to close the casing 22. The part can be transparent (to follow the tensioning process visually) or opaque (once the tensioning process has been completed). The end of the first stroke can be communicated to the operator by other means such as an electronic element by closing a circuit to the contact.

During operation with a nominal load in the drive system 11, the device 10 puts the transmission element 12 under tension; the adjustment means impose the tension in the transmission element with the resilient member 20 which is limited in deformation. The resilient member 20 is at abutment 30—possibly against the carrier 24—and its effect is inhibited. As the load in the drive system 11 increases during operation, an elongation of the transmission element may occur causing a decrease in the tension in the transmission element 12. The force applied by the transmission element 12 on the device 10 may become less than the force required to maintain the resilient member 20 at its limited deformation. In this case, there is a risk that the transmission element will go off course or no longer transmit power correctly. The resilient member 20 then allows the elongation of the transmission element 12 to be compensated. The carrier 24—and more generally, the device 10—is able to maintain tension in the transmission element via the resilient member 20. The resilient member 20 carried by the carrier 24 is moved by the carrier 24 during the second stroke of the adjustment member 18, allowing the resilient member 20 to re-apply tension in the transmission element 12, which undergoes elongation. The system is suitable for implementation in an application that operates at a nominal tension (widely used) that is very different from and lower than the maximum tension (rare case).

After tensioning both strokes of the adjustment means 18, the proposed device and system thus offer two modes of operation, one for nominal load conditions and the other for high load conditions. In normal operating mode, under nominal load, the device and system operate as a fixed tension mechanism, which is desirable to prevent vibrations. In this mode, the device is as rigid as possible. In “anti-jump” operating mode, in cases of high load, the device and system are transformed into a tensioning system with an resilient member. In this mode, the device can absorb significant elongation of the transmission element thanks to the resilient member. The two modes combined provide a good compromise between three conflicting requirements, namely: to operate with the greatest possible rigidity in order to avoid vibrations linked to an alternating deformation cycle between the transmission element and the resilient member; to allow maximum elongation of the transmission element in order to be able to transmit maximum torque without the transmission element jumping (i.e. without loss of mesh or the appearance of excessive slippage); to have as little pre-tension (during adjustment, at the end of the two tensioning phases) as possible in order to reduce friction in the system as a whole, and the forces on the transmission (bearings, for example).

The device and system is advantageous in that it avoids the need to apply a high level of pre-tension in the transmission element to cope with any rare risk of loosening under higher loads. We also avoid greater static friction and a higher load on the pulleys and bearings. As a result of the invention, it is possible to tension (pretension) the transmission element with a lower tension, corresponding to the nominal case with normal load, while being able to tension the transmission element in cases of high load to ensure correct operation of the transmission element. In addition, the device and system solve the problem of measuring tension for adjustment (tensioning)—the resilient member (such as a spring) helps to make the correct adjustment.

When a chain or belt-type transmission element is used, a pre-tension T0 can be applied, which may or may not be zero (at zero torque). During operation, a tension (proportional to the torque) is added to one strand of the transmission element and removed from the other strand. We can obtain a tension Ts which is applied in the least taut strand (or slack strand) and a tension Th which is applied in the most taut strand. When the torque in the transmission becomes too high, the tension in the slack strand Ts becomes zero, which may lead to a transmission failure (e.g., jumping of a tooth in the case of a notched chain or belt, particularly in fixed tensioner devices). This transmission fault is resolved with the device, thanks to the resilient member 20, which can take effect and catch up the slack while leaving tension.

This is illustrated schematically in FIG. 7. FIG. 7 shows the elongation E of transmission element 12 on the x-axis as a function of tension Ts on the y-axis (of the slack strand). The curve 32 corresponds to the stiffness slope of a transmission element. The tension in the slack strand of the transmission element decreases as its elongation increases. The curve 32 on the y-axis corresponds to a zero torque. Following the curve 32, as the torque increases, the curve 32 reaches the x-axis E: the taut strand becomes tighter and the slack strand becomes slack to the point that the tension becomes zero in the slack strand when the x-axis E is reached. The curve 34 shows the normal operating mode 36 of the device 10 and the system 11. As the load in the system increases, the transmission element 12 applies a decreasing reaction force against the device 10. The curve 38 shows that beyond a certain elongation 40 (or in other words, a certain elongation or elongation threshold) of the transmission element, the device 10 switches to the anti-jump mode 42 which is controlled by the stiffness of the resilient member 20. The device is able to hold the transmission element 12 in tension when the transmission element is elongated, the resilient member 20 compensating for the elongation of the transmission element.

According to FIG. 7, in comparison with the curves 32 and 34/38, it is possible to apply less tension in the transmission element for the normal operation of the system (normal mode, curve 34), with the resilient member 20 allowing tension to be applied to compensate for the elongation of the transmission element in the event of elongation beyond a certain threshold (anti-jump mode, curve 38).

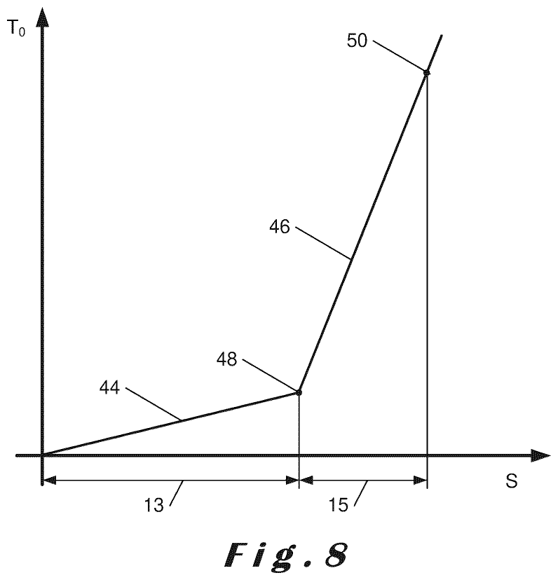

FIG. 8 shows the tensioning process. FIG. 8 shows the variation in pre-tension T0 as a function of the adjustment S of the adjustment means 18. FIG. 8 shows the behaviour of the device 10 and the system 11 during tensioning. According to the curve 44, and according to the first stroke 13, the slope depends mainly on the stiffness of the resilient member 20 and the stiffness of the transmission element 12 as seen from the device 10. Point 48 corresponds to the contact point at the abutment (i.e. the limit of deformation of the resilient member). According to the curve 46, and according to the second stroke 15, the slope depends mainly on the stiffness of the transmission element 12 as seen from the device 10. The point 50 corresponds to the pre-tensioning of the device, or in other words, the nominal adjustment point of the device.

The device 10 uses a resilient member (such as a spring), the stiffness and initial length of which are controlled. The device 10 operates at an ideal operating point, minimising the tension on the transmission element for maximum torque transmission. The device uses the known deformation (over the first stroke) and the known stiffness to obtain this desired tension in the first stroke in addition to a second tension due to the second stroke. According to the invention, a first stroke is performed up to the limit deformation (for example by making contact with an abutment), after which a second stroke is applied (for example of known length). Under normal conditions, the device is stiffer and there is less parasitic vibration compared with the prior art and in particular the document U.S. Pat. No. 6,030,305.

The device 10 allows the service life of the transmission system 11 to be increased while being lightweight, simple, compact, and inexpensive. The device 10 is a simple device that allows a system with highly variable torque to be tensioned effectively. The device offers the advantages (independently or in combination) of anti-jump operation and ease of adjustment.

The invention also relates to any apparatus comprising the drive system and in which a transmission element is implemented and which is subjected to tensioning. The invention relates in particular to a vehicle comprising the drive system. For example, the vehicle could be a bicycle or a motorbike. The bicycle or motorbike may comprise the transmission element 12, which may be a belt or a transmission chain between, on the one hand, a chainset and/or a motive power unit and, on the other hand, a wheel. The advantages mentioned for the device (light, simple, compact and inexpensive device) are particularly appropriate in the context of a vehicle where such advantages are constantly sought.

The present invention has been described above in connection with specific embodiments, which are illustrative and should not be considered limiting. In general, it will be apparent to a person skilled in the art that the present invention is not limited to the examples illustrated and/or described above.

1. A device for tensioning a deformable transmission element, the device comprising:
means for adjusting the tension in the transmission element; and
a resilient member,
wherein the adjustment means are movable:
through a first stroke, wherein the device is configured able to tension the transmission element with a first tension by way of the resilient member, the deformation of which is limited, and beyond the first stroke,
through a second stroke, wherein the device is configured to tension the transmission element with a second additional tension by way of the adjustment means, the second stroke depending on the second tension to be applied in the transmission element.

2. The device according to claim 1, wherein, during the displacement of the adjustment means over the second stroke, the resilient member is configured to be held at the limited deformation.

3. The device according to claim 1, further comprising a carrier, wherein the device is configured to tension the transmission element via the carrier.

4. The device according to claim 3, comprising a roller that is mobile in rotation with respect to the carrier, wherein the carrier is configured to tension the transmission element via the roller.

5. The device according to claim 3, wherein the resilient member is on the carrier.

6. The device according to claim 5, wherein the resilient member changes position during operation of the device upon movement of the carrier.

7. The device according to claim 5, wherein the fixing point of the resilient member to the carrier changes position during operation of the device upon movement of the carrier.

8. (canceled)

9. The device according to claim 3, wherein the deformation of the resilient member is limited by abutment by the carrier.

10. The device according to claim 3, wherein the deformation of the resilient member is limited by abutment by the adjustment means abutting against the carrier at the end of the first stroke or by the resilient member abutting against the carrier.

11. The device according to claim 3, wherein:
through the first stroke of the adjustment means, the carrier of the device is configured to tension the transmission element with the first tension by the resilient member, the deformation of which being limited, the adjustment means acting on the resilient member into limited deformation by an abutment against the carrier; and beyond the first stroke,
through the second stroke of the adjustment means, the carrier of the device is configured to tension the transmission element with the second additional tension by the adjustment means acting on the carrier, the second stroke depending on the second tension to be applied in the transmission element.

12. The device according to claim 1, wherein the resilient member is chosen from the group consisting of a leaf spring, a helical spring, a spiral torsion spring, a stud made of elastic material, and a structural piece designed to provide the appropriate stiffness for the tension to be applied in the transmission element, and
wherein the adjustment means are a screw or an eccentric.

13. (canceled)

14. A drive system, comprising:
a deformable transmission element; and
the device according to claim 1, wherein the device is configured to tension the transmission element.

15. The system according to claim 14, further comprising a casing, the transmission element and the device being at least partly within the casing, the adjustment means being accessible from outside the casing, wherein the casing comprises a sight glass for checking the first stroke and/or the second stroke of the adjustment means.

16. The system according to claim 14, wherein the device is further configured to tension the transmission element upon elongation of the transmission element during operation, the resilient member compensating for the elongation of the transmission element.

17. A vehicle with the drive system according to claim 14.

18. The vehicle according to claim 17, wherein the vehicle is a bicycle or motorbike.

19. A method of tensioning a transmission element in a drive system, the method comprising:
providing a system according to claim 14; and
tensioning the transmission element by the device, the tensioning comprising:
through the first stroke of the adjustment means, tensioning the transmission element with a first tension by the resilient member, the deformation of which being limited; then beyond the first stroke,
through the second stroke of the adjustment means, tensioning the transmission element with a second additional tension by the adjustment means, wherein the second stroke depends on the second tension to be applied in the transmission element.

20. The method according to claim 19, wherein the device further comprises a carrier, wherein the device is configured to tension the transmission element via the carrier, and
wherein the deformation of the resilient member is limited by abutment by the adjustment means abutting against the carrier at the end of the first stroke or by the resilient member abutting against the carrier.

21. The method according to claim 19, wherein the system further comprises a casing, wherein the transmission element and the device are at least partly within the casing, the adjustment means being accessible from outside the casing, and wherein the casing comprises a sight glass,
wherein the method further comprises checking the first stroke and/or the second stroke of the adjustment means through the sight glass.

22. The method according to claim 19, further comprising tensioning the transmission element by the resilient member of the device upon elongation of the transmission element during operation, wherein the resilient member compensates for the elongation of the transmission element.
